(19) United States
(12) Patent Application Publication
(10) Pub. No.: US 2005/0002518 A1
(43) Pub. Date: Jan. 6, 2005

(54) Voltage monitoring system capable of telephone off hook and ring detection

(76) Inventor: Bradley M. Daw, Orem, UT (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/771,662

(22) Filed: Feb. 4, 2004

Related U.S. Application Data
(60) Provisional application No. 60/445,285, filed on Feb. 4, 2003.

(51) Int. Cl. H04M 1/00; H04M 9/00

(52) U.S. Cl. 379/413; 379/412; 379/399.01

(57) ABSTRACT

A voltage monitoring system configured to monitor at least one of an above or below DC voltage state of a differential line pair with regard to a selected threshold voltage. The system is capable of identifying on hook, off hook, and ring DC states of a telephone line.

Priority of U.S. Provisional Application Ser. No. 60/445,285 filed on Feb. 4, 2003 is herby claimed.

### FIELD OF THE INVENTION

The present invention relates to detecting a change in the DC voltage of a differential line pair, doing so using a microprocessor which is coupled in some way to the differential line pair. More specifically, the invention relates to a system for monitoring voltage, and which is capable of detecting whether a Plain Old Telephone Service (POTS) line is in the off hook or on hook condition. The invention also relates to detecting if a POTS line is in a ringing state.

### BACKGROUND OF THE INVENTION

There are a number of instances where it is beneficial if an outside processing system such as a computer can monitor the DC state of a differential line pair. One of these is monitoring the DC voltage of a telephone line to sense on hook and off hook states. For example, call tracking and logging software typically will require some way of detecting at least off hook states. The DC voltage state of the phone line, when combined with other data gathered from the signals on the phone line, can provide useful and timely information to a computer user of such software, or of other applications relating to telephony. The discussion herein will be directed primarily to telephone line monitoring. However, it will become apparent that the monitoring system disclosed herein below can have broader application, for example in monitoring a DC voltage or low frequency (e.g. 60 Hz) AC voltage across a differential line pair with minimal interference and isolation of the monitoring system from the line pair being monitored. Thus the system can also have application in monitoring high voltage lines, battery power (i.e. voltage level) in sensitive systems, and other systems. However, for clarity of presentation the background of the problem and examples given herein will be, as mentioned, related to monitoring a DC state of a telephone line differential pair.

Proceeding now by way of background, a phone line is considered to be in use (off hook) if the DC voltage across the differential pair of the phone line is less than about 20 volts. Knowing the DC voltage across the pair enables determination of whether a POTS line is on hook, or off hook. Moreover, a large swing in DC voltage at a known frequency (in the U.S. usually about 60 Hz) typically constitutes a ring condition. Thus on/off hook and ring states can be monitored by monitoring the voltage across the line pair.

Systems for doing this are known, as will shortly be discussed, but can be relatively costly. A low-cost and reliable method for measuring the DC state of a phone line would make such a monitoring system more technically and economically feasible over a wider range of applications. However certain technical obstacles present themselves in pursuit of a low-cost system for monitoring a telephone line.

While a differential pair line used in the telephone system is a good way to transmit a signal over a long distance, monitoring the DC state of the phone lines by an external system is problematic. Tying either of the differential pair lines to the ground of the external system will disrupt a signal being carried by the differential line pair. So, the external monitoring system has to be isolated in some way. Also, the external system has to be somehow connected to a line with voltages which can range, at least under some circumstances, from −200V to 200V; which proposition in and of itself typically requires that protective measures be taken to prevent damage to the external device. Currently, external systems used to monitor the DC state of the telephone system require relatively expensive components, for example, optical isolators or other elaborate isolation measures are typically used. One way this is done is to use optical isolators and to measure each line separately and take the difference in order to obtain the DC voltage across the differential line pair.

Further in this regard, a device that is connected to both a phone line and an AC circuit (as most systems for monitoring a phone line would be as most would ultimately be powered from a standard AC power receptacle) in the U.S. typically is required by the Federal Communications Commission to have an isolation barrier capable of withstanding at least 1000 VRMS at 60 Hz with 10 mA current flow. Overall, monitoring the DC state of the differential lines with an external system can be challenging and expensive.

As mentioned, a typical method for measuring the DC state of the line is to place detection circuitry between the differential pair and/or each leg and a reference ground, and transmit the results to the external system via an optical isolator. This arrangement typically requires specialized transistors and optical isolators that are relatively expensive and still can potentially interfere with the signal on the telephone system under at least some circumstances. Other voltage monitoring systems exist which are complicated variations on this theme. The systems function by placing fairly complex detection equipment inside the differential pair of the telephone system and transmit the results to the external system over a means providing some type of DC isolation. While these methods will work, they are relatively expensive as mentioned, still can cause interference with the differential signal, and these more complex designs are also typically more vulnerable to damage from surges in the differential line pair. An example of a prior system for telephone line monitoring can be seen in the disclosure of U.S. Pat. No. 5,712,910.

### SUMMARY OF THE INVENTION

The invention provides a method for measuring a change in DC voltage on a differential line pair used in a telephone network connected to a microcontroller, comprising the steps of: a) injecting a pulse signal from a microprocessor onto a first line of a differential line pair; b) biasing the differential line pair with a bias circuit comprising a first Zener diode that is in series with and in opposite polarity to a second Zener diode, each Zener diode having a break down voltage so that a change in voltage can be detected on either the first line or a second line of the differential line pair; c) isolating the microcontroller from a DC voltage on the differential line pair; d) protecting the microcontroller from surges and spikes on the differential line pair; and e) detecting the microcontroller-generated pulse on the second line of the differential line pair with the microprocessor when the voltage difference between the first line of the differential line pair and the second line of the differential line pair is greater than a preset level.

In a more detailed aspect, a telephone system monitoring system in accordance with principles of the invention can be configured to detect at least one of on hook and off hook DC states of a differential POTS line pair, and will include several elements. A detection circuit is provided and configured to isolate the line pair from the rest of the detection circuit by means of capacitors in the line pair; said detection circuit further comprising means for sending pulse signals across the capacitors and means for returning or preventing return of the pulse signals depending upon whether the DC voltage differential across the line pair is above or below a selected threshold value. The system will include means for indicating whether the voltage across the differential line pair is at least one of above or below the threshold value. This can be used to sense when a pone line is in at least one of an on hook and an off hook condition.

In a more detailed aspect, the invention can further comprise a means for detecting a ring condition on the POTS line. Moreover, in application to telephone line monitoring the system can be combined with an appropriately configured and programmed computer system for telephone call identification, logging and timing, and the system can include, in this regard, means for indicating initiation and termination of a call based on differentiating an on hook and an off hook DC voltage state corresponding to the DC voltage across the differential line pair being above or below the threshold voltage.

In another more detailed aspect, such a system can further include means for identifying a window for capturing caller ID information in a signal carried by the differential line pair. In a further more detailed aspect, the means for sending pulse signals can include an appropriately programmed microcontroller.

Additional more detailed aspects include those wherein the detection circuit comprises means for minimizing the disruption of the DC voltage of the POTS differential line pair by the detection circuit; and wherein the means for minimizing disruption includes a low pass filter. The detection circuit can further comprise a protection circuit portion configured to minimize effects of anomalous voltage and current conditions on the differential line pair on the microcontroller.

In further more detailed aspect, the detector circuit can be configured to function regardless of polarity of the differential line pair. Also, the programmed microcontroller can be configured to comprise a means to minimize the effects of noise on the differential line pair on detection of the DC state of the differential line pair.

In further detail, the pulse signals can be square wave pulse signals; and can be passed by a capacitive DC isolation circuit portion but be attenuated by a low pass filter portion, and thereby not disrupt signals on the system being monitored. These pulse signals can be initiated at a fairly high periodic frequency, for examples at time intervals of less than 16 milliseconds, and can be sent at other, longer, time intervals. The pulse signals can be configured to be less than 20 microseconds in length from positive edge to negative edge.

In another more detailed aspect, microcontroller can include a data link capability to communicate with another processor. Such other processor can be a PC or other computer system, or a user interface of sonic kind. The system can be configured so that the microcontroller capability is minimized and timing and logic functions are moved to said another processor, or in another case microprocessor capability is maximized and the detection circuit is connected to a user interface wherein the possessing required in the interface is minimized.

In further detail, the system, including the detection circuit can be implemented on a PC card. Alternatively, the detection circuit can be implemented in a separately powerable unit, which unit is data connectable to a computer.

### BRIEF DESCRIPTION OF THE DRAWINGS

FIG. 1 is a schematic representation of a system in accordance with one embodiment of the invention showing an example environment thereof.

FIG. 2. is a schematic illustration of an exemplary embodiment of a voltage detecting circuit in accordance with principles of the invention.

FIG. 3 is a flowchart illustrating an algorithm including steps taken by the microprocessor shown in FIG. 2 in detecting the voltage of the differential pair in one example embodiment.

FIG. 4 is a flowchart illustrating an algorithm including steps taken by the microprocessor shown in FIG. 2 specific to a telephone line monitoring application for detecting the hook condition as well as the ringing state.

FIG. 4A is a flowchart illustrating a timer check algorithm used with the algorithm shown in FIG. 4.

### DETAILED DESCRIPTION

Reference will now be made to the exemplary embodiments illustrated in the drawings, and specific language will be used herein to describe the same. It will nevertheless be understood that no limitation of the scope of the invention is thereby intended.

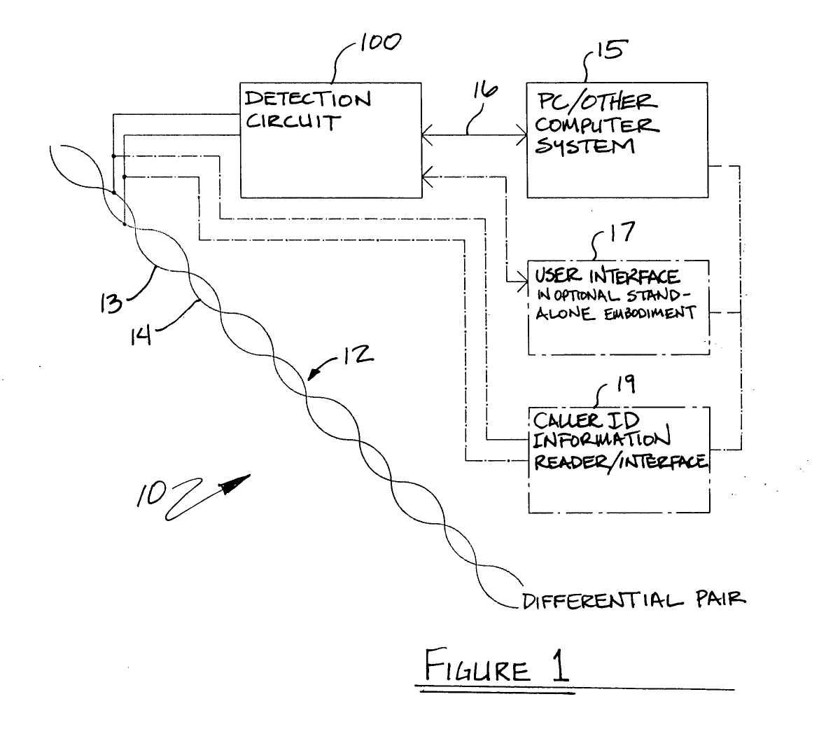

With reference to FIG. 1, a voltage monitoring system 10 is configured to monitor the voltage across a differential line pair 12. The system can comprise a detection circuit 100 in accordance with principles of the invention connected to each line 13, 14 of the differential line pair which has an associated voltage differential, comprising a voltage under test. As will be appreciated, the voltage under test can be of another form, for example a high voltage power line, a sensitive battery powered system, etc. as mentioned above. The voltage under test can be modeled as a battery, for example, having an associated potential and inherent resistance (not shown). However, it is the voltage differential, and how it is changing, that is of interest; and so the inherent resistance can be ignored for purposes of explaining the invention, particularly since the inherent resistance of the detection circuit 100 is much higher than the series resistance of a telephone line pair, for example.

The detection system 10 can be implemented using a PC or other computer system 15, appropriately programmed to cooperate with the detection circuit to perform tasks needed for a particular application. For example, in a telephone call logging application the computer system is programmed to use the output of the detection circuit to log such things as the time of day a telephone call is made or received, the identity of the caller and recipient, the length of the call, etc. A connection 16, such as a USB, legacy standard, firewire, or a custom protocol connection is provided between the detection circuit and the computer to transmit information needed to accomplish the tasks mandated by the application, and which will be discussed in more detail below. In another embodiment, a stand-alone system is provided, and includes a user interface 17 so that a user can have access to information or otherwise control the system 10 according to the particular application. It is assumed that in either embodiment that an appropriately programmed microcontroller (not shown) or more than one, is used. Whether most of the processing capability is associated with the detector circuit 100, or is moved to a computer system 15 having comparatively much larger processing and memory capability depends on the application of the invention. For purposes of simplicity, it will be assumed herein that the system 10 employs a PC running appropriate telephony software for the application, and that the detection circuit has a microprocessor with limited capability, to keep cost to a minimum. For example, as will be apparent from the disclosure herein the microprocessor can have a timing capability, or not, and can be capable of detecting ring states, or not, and if not this capability can be moved over to the PC if it is needed. In telephony-related applications where caller ID information is harvested an appropriate interface 19 for this purpose can be provided, which like a user interface, may or may not involve or be connected with a PC 15.

As mentioned, isolation of an AC-powered circuit (such as the computer system 15, or even a portion of the detection circuit 100 itself) from the phone line 12 is mandated by the FCC; and to accomplish this, many prior art systems use optical isolators (not shown) to provide the necessary isolation for circuits designed for off-hook and ring detection in a telephone line monitoring circuit. While photo-couplers, or other optical isolators, are useful in isolating an AC circuit from the phone line, optical isolators typically are expensive as discussed. This can drive up the cost of the circuit, limiting its use in many applications where cost control is a priority. As will be appreciated, cost control is very important throughout the computer industry, and so many applications involving monitoring of a POTS line may simply not be pursued due to the cost involved.

In order to overcome the problems described above, and to provide an inexpensive and simple solution, the present invention provides a system 10 configured for a detection of at least one of a on hook, off hook, and ring condition on a differential line pair 12 in a telephone network system. The particulars and operation of the system will now be explained.

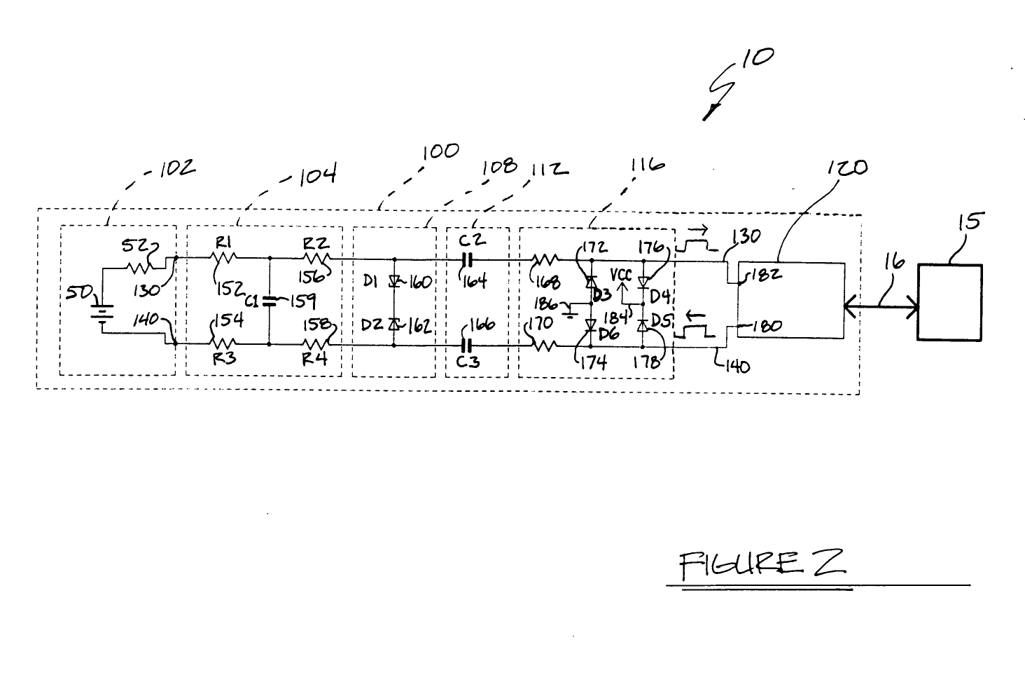

With reference to FIG. 2, an example system 10 in accordance with principles of the invention includes a detection circuit 100 for detecting the voltage across a differential line pair of a telephone system (not shown) while maintaining DC isolation from the differential line pair of the telephone system. At a conceptual level, the detection circuit 100 includes a voltage under test portion 102 representing the line pair (not shown) by a voltage differential (shown as a battery) 50 and a resistance 52. From this point it will be assumed that the voltage differential is unknown, and that the series resistance of the line pair can be ignored, as mentioned, for several reasons, and here primarily because in a telephone monitoring application the voltage across the line pair can be monitored for the information needed without knowing the series resistance as it is comparatively so small that it does not affect the performance of the detection circuit 100 as will be apparent from the following discussion.

The voltage under test portion 102 for purposes of this discussion will include the hardware that enables the circuit 100 to be electrically coupled to the differential line pair of the telephone system (not shown). This can be conventional; comprising cable and connectors, and the like depending on whether the circuit is on a PC card, in a separate “black box” or depending otherwise upon the specifics of the arrangement.

The detection circuit 100 includes a low pass filter 104 between the voltage under test 102 portion and the rest of the circuit. A bias circuit portion 108 is electrically coupled to the low pass filter 104, and can function as described below. A DC isolation circuit portion 112, which in this system is of comparatively low cost, can be electrically coupled between the bias circuit 108 and a protection circuit portion 116. The protection circuit simply provides a path for anomalous high voltage transients to be dissipated without damaging a micro controller 120 included in the circuit. The microcontroller is configured to send periodic pulses of short duration and of a frequency high enough to not pass through the low-pass filter portion 104 out onto the line pair connected to the detection circuit 100. The frequency selected should be above about 120 Hz anyway, if ring detection is to be provided, as changes in voltage at a ring signal frequency of 60 Hz will not be reliably detected at a pulse signal frequency below that, as the pulse frequency will correspond to a sampling frequency as will be apparent from this disclosure. The microcontroller is configured to detect whether these pulses return, or not. The microcontroller and can be programmed to send signals indicative of the DC state of the telephone line (i.e. on hook, off hook, or ringing) to a computer 15 via a data connection 16 such as a USB connection. A more complete description of the detection circuit follows.

In the embodiment illustrated, the low-pass filter 104 comprises a first resistor (R1) 152 and a second resistor (R2) 156 on the first line 130 connected to one of the differential line pair and a third resistor (R3) 154 and fourth resistor (R4) 158 on the second line 140 connected to the other line of the differential line pair. A capacitor (C1) 159 is electrically coupled to and between the first line 130 and second line 140 connected to the differential line pair, the points of connection being disposed between the first and second resistor 152 and 156 of the first line 130 and the third and fourth resistor 154 and 158 of the second line 140.

The low-pass filter 104 is conventional, and is configured to pass only low-frequency signals of less than about 120 Hz. A ring signal is at about 60 Hz typically, and so will pass. Interestingly in this application the low-pass filter can serve three purposes. First, the filter 104 can present a DC resistance of at least one mega-ohm across the line pair. In this application this is important because telephone system specifications for connectable devices require at least that resistance. Second, the filter 104 can attenuate higher frequency signals from the line pair/voltage under test section 102, so as to minimize the effect that such signals might otherwise have on the rest of the detection circuit 100. Third, the filter can attenuate the pulse signal generated by the microcontroller 120 of the detection circuit 100, which will be at a frequency higher than about 120 Hz, so that said pulse signal will have a minimized impact on the voltage under test. That is to say, for example, that a telephone line included in the voltage under test portion 102, and telephonic signals that may be carried on the line pair of that line, will be essentially isolated from such pulse signals.

In the illustrated embodiment, the bias circuit portion 108 comprises a first Zener diode 160 in series with, and disposed in opposite polarity from, a substantially identical second Zener diode 162. Each Zener diode has a breakdown voltage of a selected threshold value chosen so that a change in the voltage on the line pair (the voltage under test portion 102 across lines 130 and 140) from above to below the threshold value, or vice versa, can be detected by the circuit 100 as will be described below.

As an aside, in an alternative embodiment where the polarity of the differential line pair is known in advance, it will be appreciated from the discussion below that only one Zener diode can be used. The pairing and opposite polarity configuration of the bias circuit illustrated is provided to enable its function regardless of polarity of the line pair; but this is not usually required in a case were the polarity of the voltage under test is always the same.

In operation, when the voltage under test (i.e. across lines 130 and 140 of the voltage under test portion 102) is greater than the breakdown voltage of the Zener diodes, which are selected to be the same, the bias circuit 108 will conduct current (regardless of polarity), and thus will allow a pulse (as will be discussed below) from the microcontroller 120 to pass through it, e.g. from the bottom line 130 to the top line 140 in the figure. When the voltage under test 102 is lower than the breakdown voltage of the Zener diodes, the bias circuit 108 will not conduct current, and no pulse signal from the microcontroller 120 will be able pass through bias circuit from line 140 to line 130.

In the illustrated embodiment, the DC isolation circuit 112 can comprise a capacitor (C2) 164 electrically coupled in the first line 130 connectable to one of the differential line pair (top in the figure) and another capacitor (C3) 166 electrically coupled in the second line 140 (bottom in the figure) connected to the other line of the differential line pair. The two capacitors of the DC isolation circuit 112 operatively connect the microcontroller 120 and protection circuit 116 portions to the rest of the detection circuit 100, yet provide DC isolation.

In operation, the C3 (third) capacitor 166, of the DC isolation circuit portion 112, which is electrically coupled to a microcontroller output pin 180 on the (bottom in the figure) line 140, will pass a square wave pulse generated by the microcontroller virtually unmodified if the pulse duration is short enough. For example a 3.3 volt square wave pulse of 15 microseconds duration will pass essentially unaltered to the bias circuit portion 108. If the bias circuit is in a conducting state (the voltage differential is above the threshold value), the pulse sent by an output 180 of the microcontroller 120 will pass unmodified through the bias circuit to the second (C2) capacitor 164 on the first differential line 130. This capacitor will likewise pass such a pulse, and it will travel back to the microcontroller and will be received on an input pin 182. If the bias circuit 108 is not in a conducting state (the differential is below the threshold value), the pulse sent by the microcontroller will be prevented from passing from the bottom line 140 to the top line 130 and to the second capacitor 164.

As will be appreciated, assuming the breakdown voltage threshold of the diodes are the same (which they will not be due to manufacturing tolerances, but they will be within 5 or 10 percent of the selected value, depending on cost) and is 20 volts, and the pulse is about 3 volts in magnitude, the pulse will begin to pass as the voltage across the differential line pair approaches and gets within 3 volts of the threshold, and will continue to pass the pulse as long as the voltage across the pair remains above the threshold value. The bias circuit portion will stop passing the pulse when the voltage across lines 130 and 140 drops below within about three volts of the threshold, i.e. about 17 volts. As will be appreciated at least one Zener diode will not pass current as long as the differential is below the threshold, so, regardless of polarity of the voltage differential, the pulse will not pass at differentials below about 17 volts and will essentially always pass at differential voltages above 20 volts. The answer to the question of whether the pulse is or isn't passed, and accordingly whether the voltage is above the threshold, or not, will be used by the system as described hereinafter.

The protection circuit 116 in the illustrated embodiment can be configured to prevent surges and spikes in the differential line pair (connected on lines 130 and 140) from causing an over- or under-voltage condition at the microcontroller 120. In one embodiment, the protection circuit can comprise a first resistor 168 in the first (top) line 130 connected to one the differential line pair, and a second resistor 170 in the second line 140 connected to the other of the differential line pair. These resistors are positioned between the DC isolation portion 112, on the left in the figure, and the rest of the protection circuit 116. A first diode (D3) 172 of a diode pair is connected in series with and is of opposite polarity with and from a second diode 174 of the pair. The pair of diodes are electrically coupled between lines 130 and 140 corresponding with the differential line pair, such that the cathode side of each diode 172 and 174 are electrically coupled to the first and second resistor 168 and 170 respectively. The anode side of each diode 172 and 174 of the pair can be connected to ground. Another diode pair, including a first diode (D4) 176 and a second diode (D5) 178 in series with and disposed in opposite polarity therewith are electrically coupled between lines 130 and 140 corresponding with the differential line pair. The anode side of each diode 176 and 178 are likewise electrically coupled to the first and second resistor 168 and 170 respectively, in parallel with the first set of diodes. The cathode side of each diode 176 and 178 can be connected to a supply voltage (Vcc) line 184 of the microprocessor 120.

The protection circuit portion 116 essentially operates as a safety valve, and provides a path for dissipation of transients. A spike that cannot be absorbed by the microcontroller 120 is able to exit via the protection circuit's connections to the supply (Vcc) 184 and draw from the ground 186 as needed. This protection circuit portion can be replaced by a transorb or other structure having equivalent functionality. In the illustrated embodiment, the microcontroller 120 is configured for detecting the voltage state of the differential line pair in accordance with the foregoing discussion. The digital output 180 pin coupled to the line 140 (bottom in the figure) corresponding to one line of the differential line pair, facilitates the Microcontroller sending generated square wave pulse signals in that line. The microcontroller can have a Schmitt trigger (hysteresis) input pin 182 electrically coupled to the top line 130 (in the figure) connected to the other line of the differential line pair. This enables detecting whether the pulses sent on the output connected to line 140 are returned on line 130. This will only happen if the voltage differential of the connected line pair is at a level greater than a preset level commensurate with the breakdown voltage selected for the Zener diodes 160, 162 of the Bias circuit portion 108. That preset level can be defined by the breakdown voltage of a single Zener diode if polarity of the line pair is known, as mentioned above. If the differential is great enough, the bias circuit portion passes the pulse from the microcontroller from one line 140 to the other line 130. If the differential is not great enough, i.e. greater than the breakdown voltage of the relevant Zener diode (D1 or D2) the pulse will not pass; and so it will not be returned to the input of the microcontroller. The purpose of using a Schmitt trigger type input is to reduce false detects (in this case, the start or end of a pulse) due to noise on the line pair, as it tolerates some fluctuation in input voltage without indicating receipt of a beginning or end of a pulse.

An example of a microcontroller 120 suitable for use in the illustrated embodiment is a model CY7C63001 A-SC controller made by Cypress Semiconductor Corporation of San Jose, Calif. This model includes a USB connection (16 in the figures) enabling connection to a PC 15 or another device as required by the application to which the system is put.

As will be appreciated the circuit can be incorporated on a PC card, and supplied with power by the PC it is connected to. In another example, it can be incorporated in a separate housing with its own power supply (184, conventional, and not otherwise shown) and connectable by a USB cable to the PC 15.

To further illustrate the invention by example, when the voltage under test 120 is that of a differential line pair comprising a POTS line (12 in FIG. 1) of the telephone system, the voltage under test 120 can be the typical voltage differential of about 40 volts when the line is on hook. The voltage can drop, for example, to a typical level of about 5 volts when the line goes off hook. While the phone line is in use, the voltage under test 102 portion can comprise voltage differentials which typically vary between 0 and 10 volts assuming conventional signal types are being carried by the POTS line.

If the Zener diodes 160 and 162 have a selected threshold, i.e. breakdown, voltage of 20 volts, the bias circuit 108 will not conduct during a typical off hook condition, as the voltage differential will remain well below the 20 v threshold. Thus, aside from a ring condition to be discussed below, the bias circuit 108 will, under ordinary circumstances, only conduct current, and thus pass pulse signals from the output 180 to the input 182 of the microcontroller 120 during conditions where the line condition is typically considered to be on hook.

The system 100 shown in FIG. 2 functions as an off hook and ring detector when the voltage under test portion is connected to the differential line pair (12 in FIG. 1) of a telephone system. The square wave pulse signal, in one embodiment comprising pulses of 15 microsecond duration and of 3.3 volts, can be generated by the microcontroller 120 at a frequency in one embodiment of one pulse every 5 milliseconds. It will therefore have a “frequency” of 200 Hz, and so will not pass the low pass filter portion 104, and will be able to reliably detect a ring signal voltage swing of 60 Hz. This pulse signal is output from the microcontroller 120 onto the second line 140 of the differential line pair as explained above. A higher frequency can be used, and if no ring detection is required a lower frequency of pulse signal can be used, provided it is filterable by the low pass filter 104.

The microcontroller-generated pulse signal can travel through the protection circuit portion and capacitor 166 in the line in the DC isolation portion 112, but not through the low-pass filter out into the line pair. The Zener diodes 160 and 162 in the bias circuit have a selected breakdown voltage as explained, and if this is (for example) 20 volts, depending on the cost of the components they will have a breakdown voltage in a range between say 18 and 22 volts, or 19 and 21 volts, where the tolerances are 10 and 5 percent, respectively (by way of example). When the voltage between the differential line pair is above the breakdown voltage range the Zener diode pair will conduct current and allow the pulses generated by the microcontroller 120 to pass through the bias circuit portion and back through the capacitor 164 of the DC isolation circuit portion and the protection circuit portion and be detected by the input pin of the microcontroller connected to line 130. When the voltage difference in the differential line pair is below the breakdown threshold the Zener diode pair 160 and 162 will not conduct current and the pulse signal generated by the microcontroller will not be passed between the lines 140, 130 to be detected at the microcontroller's input. In either case the pulse signal will be prevented from crossing through the low pass filter 104, and so it should not be measurably detected on the differential line pair of the telephone system.

The condition of the phone line can be determined by sensing whether the voltage is above or below the threshold value, and is remaining there. As mentioned, on hook involves a relatively steady differential of about 40 volts, whereas off hook typically implicates a voltage of about 5 volts, varying usually between 5 and 10 volts with a typical signal being carried by the line. Thus by selecting a threshold voltage between 10 and 40 volts, say 20 to 30 volts, when the pulse signal is passing or not passing and thus being detected or not indicates the on/off hook state. If the pulse signal is detected for a specific period it can be determined that the phone is on hook. Like wise if the microcontroller-generated pulse signal is not received at the input pin for a specific time period, then it can be determined that the phone is off hook. Moreover, since a ring condition involves a periodic voltage swing in the line pair from about 40 down to about 10 volts, it will repeatedly cross the threshold voltage value. Thus if the microcontroller-generated pulse signal is received and not received at the input of the microcontroller 120 for periods of time of a periodic frequency corresponding to a telephone ring signal frequency, it is possible to detect that the phone is ringing by identifying that the microcontroller-generated pulse signal appears to be switching on and of at the input pin at a frequency within a range commensurate with a range of possible ring condition voltage swing frequencies in the line pair under test, i.e. the ring signal of a POTS line.

As mentioned above, being able to monitor, and thus track in time the condition of a phone line can be useful. For example, knowing the length of a telephone call or whether or not the phone was answered can be very useful information, e.g. in time tracking and billing applications, telephone use logging, call center employee performance tracking, just to name a few applications. Being able to obtain and track such information by means of a computer greatly enhances its availability usefulness.

The system illustrated can be stand alone, and the microcontroller connected to memory and hardware as required to perform the monitoring function needed. In another embodiment the microcontroller can be connectable to a computer appropriately programmed for the monitoring function. The connection can be of a standardized type, such as USB, legacy, Firewire, etc. or can be customized to the application.

The microcontroller can be quite inexpensive, and passing only a pulse signal indicative of a state change to a computer, whereby timing functions and other complexity can be moved to a computer to which it is connected. In a stand-alone application the processing power of the microcontroller can be extensive, allowing on and off hook and ring detect, and call timing as well as caller ID monitoring functions. It will be appreciated that in the embodiments where the detection circuit 100 is linked to a computer 15 at one extreme the processor 120 can be selected to be very capable and perform all the timing and logic functions of the DC state monitoring of the phone line 12 for the application, and will simply give the information to the computer as required. At another extreme the microprocessor is selected and configured to be very “dumb” and simply relays raw state change data to the computer system, which instead performs all the timing and logic functions required. The example embodiments herein are generally to be considered in between these two extremes, but the extremes and the variations between will be appreciated as viable alternative embodiments to those skilled in the art.

The system simplifies caller ID monitoring. Since caller ID information is passed between the first and second ring, and the system can sense rings by determining if the line differential voltage passes through the threshold up and down at intervals consistent with a 60 Hz telephone ring signal. An example of how this can be done is set out in detail farther below. Returning to the subject at hand, having detected a first ring, the monitoring system 10 in accordance with programming can be instructed to activate a Caller ID recording program portion and listen for and record the caller ID information sent via a signal on the differential line pair. The system can alert a user that a call is coming in, and post the caller ID information, in addition to logging the information.

It will be appreciated that in order to implement such a system the detection circuit 100 in the illustrated embodiment can be linked to a computer 15 appropriately programmed to use information generated by the microcontroller 120 to provide this functionality.

Being able to equip a computer with the components necessary to accomplish the gathering of telephone line state information inexpensively and reliably is enabled by the invention described by example herein. An inherent advantage of this system is an ability to detect when the phone line is ringing (in addition to on/off hook states) with no additional circuitry, only additional software in the controlling microprocessor 120.

As will be appreciated from the foregoing, the detection circuit 100 can be configured so that it maintains full DC isolation from an outside line pair (12 in FIG. 1) thus protecting sensitive computer equipment, peripherals and other electronic equipment. Likewise, the circuit minimizes the effect the monitoring has on signals carried by the line pair.

An example of a circuit illustrated in FIG. 1 includes the following components:

| Component | Reference # | Value | Additional Parameters |
|---|---|---|---|
| C₁ | 159 | 0.1 μF | 100 v Non-Polarized |
| C₂ | 164 | 0.1 μF | 100 v Non-Polarized |
| C₃ | 166 | 0.1 μF | 100 v Non-Polarized |
| R₁ | 152 | 250 K ohm | |
| R₂ | 156 | 250 K ohm | |
| R₃ | 154 | 250 K ohm | |
| R₄ | 158 | 250 K ohm | |
| R_{Prot 1} | 168 | 4.7 K ohm | |
| R_{Prot 2} | 170 | 4.7 K ohm | |
| D₁ | 160 | 20 v | Zener, 20 v Threshold, |
| | | | 1 mA Capable |
| D₂ | 162 | 20 v | Zener, 20 v Threshold, |
| | | | 1 mA Capable |
| D₃ | 172 | — | 1 mA Capable |
| D₄ | 176 | — | 1 mA Capable |
| D₅ | 178 | — | 1 mA Capable |
| D₆ | 174 | — | 1 mA Capable |
| Microprocessor | 120 | CY7C63001A-SC | w/USB |

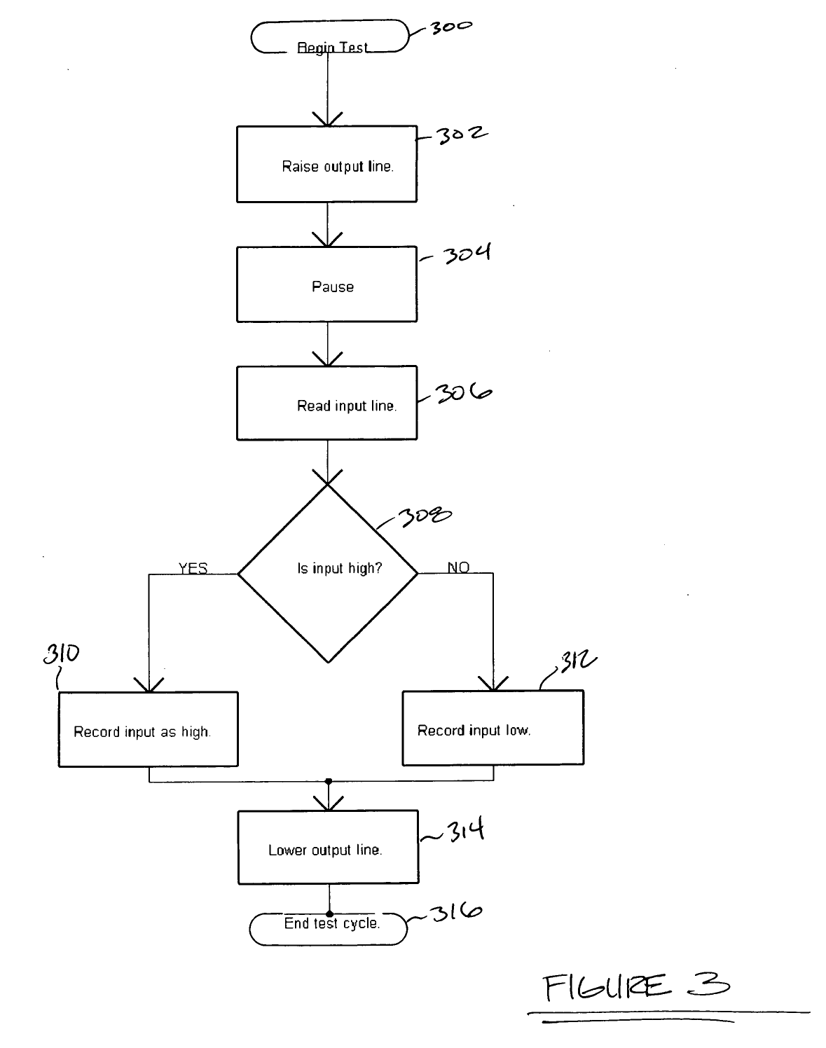

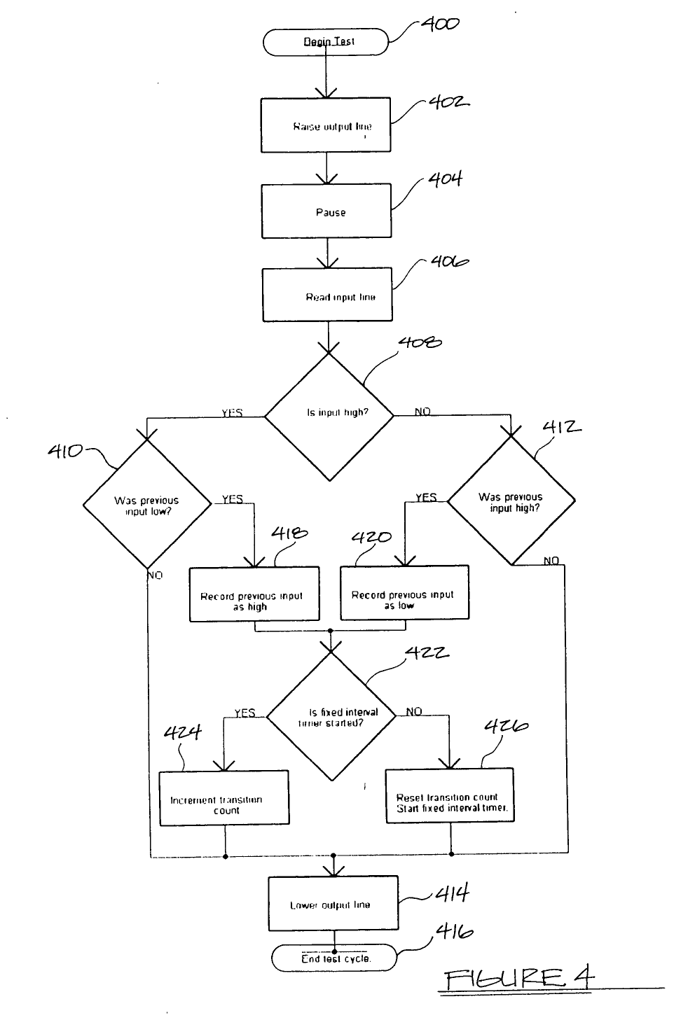

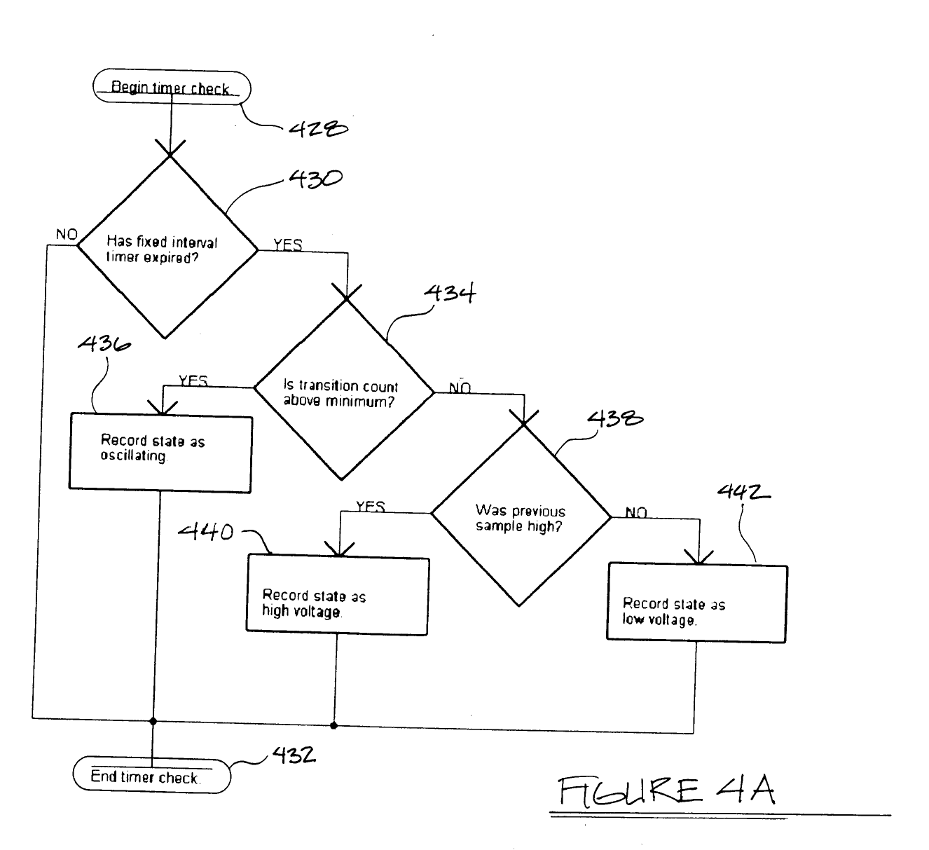

Turning now to more detailed examination of the operation of the microcontroller 120 with the detection circuit 100, example Algorithms for programming the microcontroller are shown by way of exemplary flowcharts in FIGS. 3, 4 and 4A. FIG. 3 shows an example for determining whether the voltage across the line pair, i.e. the voltage under test (102 in FIG. 2) is above or below the selected threshold value determined by the breakdown voltage of the Zener diode(s) (e.g. 160, 162 in FIG. 2). At the beginning 300 of the test cycle the first step 302 is to raise the voltage on the output pin (180 in FIG. 2) from a low voltage state to a high (e.g. 3.3 v) voltage state. In the next step 304 the microcontroller pauses a few microseconds. Then in step 306 it reads the input line (182 in FIG. 2). At step 308 the algorithm branches, depending on whether the input is high (raised by about 3.3 volts commensurate with the output line, indicating the pulse has passed through the bias circuit 108 in FIG. 2) or not. If the input is high this is recorded at step 310, and if not, it is recorded as low at step 312. This information can be used by the system (10 in FIG. 1) to determine if a POTS line is on hook or off hook in accordance with the forgoing discussion. At step 314 the output line is brought low, to a low voltage state, an this is done at a time after step 302 defining the length of the pulse. This pulse length is about 15 microseconds in one embodiment, as mentioned. The test cycle then ends at step 316 and the microcontroller can be programmed to wait a certain amount of time before initiating another test cycle. In one embodiment the wait can be selected to be in the range of about one half to 5 milliseconds, i.e. a test frequency (pulse initiation frequency) of about 200 to 2000 test cycles per second.

Whether the input is high or low is indicative of whether the voltage under test 102 is above or below, respectively, the threshold, and can indicate whether a battery is low, a power supply voltage has risen or dropped unacceptably, or as is the main exemplary application a POTS line is on hook or off hook, as set forth above. However, noise on the line could result in spurious high or low voltage detections. Having a Schmitt-trigger type input on the microcontroller 120 helps reduce false detects, but a modification to the forgoing algorithm can further reduce them, and is a lower-cost solution than adding additional analog filters to the voltage under test side (phone line side) of the circuit 100, which analog filters can involve RF chokes and high-voltage capacitors, for example.

The modification is that at the beginning of the test cycle (300 in FIG. 3), before the microcontroller sends out a pulse (i.e. before step 302) it reads the input line. If the input line is high, it skips one cycle altogether. If the input is low, the microcontroller sends out the positive edge of the pulse and reads the input (steps 302, 304, and 306) and records whether it is high or low. The microcontroller then sends out the negative edge of the pulse (brings the output low), and again reads the input line and compares it to the previous read. If the input line remains high then the micro controller ignores the entire read cycle and waits for a new test cycle, because the high read is probably noise because the output has already gone low. If the first read is low and the second is low, then it is a valid read and the recorded low read is retained. Likewise if the first read is high, and the second is low, then the first, high, read is retained as it is presumed valid because the second read occurring after the negative edge of the pulse was passed confirms that noise is probably not responsible for the initial high read, but rather that the pulse was actually passed. This modification of the algorithm can improve performance, giving a good level of noise rejection without additional component cost.

Turning now to FIGS. 4 and 4A, an oscillating voltage condition can be detected, for example a 60 Hz telephone ring signal, in accordance with the foregoing discussion, using an algorithm as follows, by way of example. At a beginning step 400 of a test cycle the output (180 in FIG. 2) is brought high creating the positive edge of a pulse at step 402. The next step 404 is a pause of a few microseconds, and then at step 406 the input line (182 in FIG. 2) is read. At a branching step 408, if the input reads high the algorithm branches left in the figure to step 410 where it is queried whether the previous input line read was low. If It was not low then the voltage has not crossed the threshold since the last cycle. This new read as high at the input is recorded and the process passes to step 414 where the negative side of the pulse is output by the microcontroller, at the output and the test cycle ends at step 416. The microcontroller waits a selected period of time before initiating a new cycle. Likewise. if at step 408 the input read is low then the algorithm branches right in the figure to step 412, where it is queried whether the previous input read was high. As will be appreciated, in either branch the program is determining whether there has been a state change on the input line between the previous cycle's read and the read at line 406 of the present cycle. Again, if there has been no change the algorithm branches to step 414 and the test cycle repeats as just described. If, on the other hand, the branching test at step 410 or 412, as the case may be, indicates that the state of the input has changed since the last cycle, the program branches to one of steps 418 and 420, respectively.

Timing between state changes is implicated in identifying an oscillating signal swinging back and forth across the threshold voltage value from above and below the threshold voltage value. The timing can be applied in a number of ways, for example, timing the length of time between state changes, and if an average time between state changes over a selected period is within a range commensurate with a ring signal (or another oscillating condition being looked for), then the algorithm can signal that the DC voltage oscillation looked for has been found. In another example the microcontroller can time the intervals between state changes of one direction, i.e. the occurrence of arrival of the positive edge of the pulse or the negative edge of the pulse. Again, if the time between these events is within a selected range over a selected period this is indicative of an oscillation across the threshold voltage value at a looked-for frequency. Another, and more simple approach is simply to count the number of times the state changes over a given time interval, and repeat this and if the count in any period is within a range selected to be indicative of the looked-for frequency of the oscillating DC signal, then the microcontroller can signal that the condition exists. An even more simple twist to this approach is to begin a timer interval upon detecting a state change, if the timer is not already running, thereby initiating timing only when a state change occurs, the first time it occurs after the selected timing interval has expired, thereby allowing the timing function to idle most of the time.

Accordingly, in the illustrated embodiment at step 422, having determined that the threshold has just been crossed the algorithm queries whether a fixed interval timer has previously been started (by a previous cycles state change detect) and if it has, it branches to step 424 where a counter is incremented by one, accounting for another state change within the interval being timed. If not, indicating this is the first change detected, then the counter is reset and the interval timer started at step 426.

Looking now more specifically and FIG. 4A, the testing for an oscillating voltage using the timing function is illustrated beginning at step 428 where a timer check is initiated. At branching step 430, depending on whether the selected fixed time interval (for example 50, 100 or 150 milliseconds) has expired, the algorithm ether branches left in the figure if the time interval has not expired, to step 432 and timer check cycle ends and will begin again at line 428 on the next cycle, or branches right to step 434 if the time interval is up. At branching step 434 the test is whether the count of transitions of the threshold voltage is above a selected number. That selected number can be a minimum amount indicative of a frequency of voltage swing above a certain value. For example, if a timing interval period of 100 milliseconds is used a count of 10 or more state changes (two for each full swing period) or 5 or more threshold crossings in a given direction (one for each swing period), will indicate an oscillation of at least 50 Hz, and within acceptable certainly that a ring signal (at a nominal 60 Hz) is detected on a POTS line. In that case the algorithm branches left in the figure to step 436 recording the state of the voltage as oscillating at a frequency above the selected frequency, and in the case of a POTS line that a ring is detected. Otherwise the algorithm branches right in the figure to step 438 where the state is sampled and recorded as high or low at steps 440 or 442, respectively, and then to the end of the timer check at step 432 where the system waits for the next timer check cycle to begin.

Other algorithms can be used for determining on hook, off hook and ring states. But in any case it will be apparent that the particular design of the detection circuit 100 allows detection of all three possible DC states of a POTS line at comparatively much lower cost than previous systems because most of the complexity is moved from hardware into software (or firmware) and this allows substantial per-unit cost savings.

Having a ring detect capability in addition to on hook and off hook detect is advantageous in a telephone use logging/tracking system for a number of reasons. One is that an attempted contact is positively discerned by such a system. Another, perhaps more important one is that systems that track the Caller ID will operate more efficiently, and the software coding of such a system is simpler, if the system can know when the caller ID information will be passed. The caller ID information signal is sent between the first and second ring signals conventionally. Therefore if rings can be detected by the system then the window for receiving the caller ID information is identifiable, and this enables the system to ignore spurious ID signals and only look for the caller ID signal within the identified window between the first and second ring of each call detected This allows the monitoring system to be idle a larger percentage of the time, draw less power, and as mentioned, have more simplified programming.

As will now be more knowledgably appreciated, a system in accordance with the invention enables an isolated DC monitoring system for use with a differential line pair which utilizes less expensive components, still maintains isolation between the outside system (such as the detection circuit and a computer) and the differential line pair. In the case of a phone system, the system can be configured so that it causes negligible interference with the differential line signal. A system in accordance with the invention also provides a high degree of invulnerability to transients and surges in the differential line for the external system.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

1. A voltage monitoring system configured for monitoring a DC voltage of a differential line pair with respect to a threshold voltage, comprising:
a detection circuit comprising a first line and a second line, each line connectable to one of the two lines of the differential line pair, said detection circuit further comprising:
a low pass filter configured and disposed in relation to the first and second lines to pass a DC signal of steady state or low-frequency voltage swing from the differential line pair to the rest of the detection circuit, and to block a pulse signal from a microcontroller set forth herein below from passing between the first and second lines;
a bias circuit portion comprising at least one Zener diode, disposed between the first and second lines and configured to allow current to flow, and accordingly to pass said pulse signal, between the first and second lines when the voltage across the differential line pair is above a selected breakdown voltage of the Zener diode;
a DC isolation portion comprising a pair of capacitors disposed in the first and second lines, said DC isolation portion configured to pass said pulse signal, and to impede other DC signals from the differential line pair from passing from the differential line pair to said microcontroller; and,
said microcontroller, configured to send and detect pulse signals, and to detect when the DC voltage across the line pair is at least one of above and below the threshold value, and to thus enable monitoring of the differential line pair in this respect;
the low pass filter being disposed between the line pair and the other elements of the detection system, the bias circuit portion being disposed between the low pass filter and the DC isolation portion, and the DC isolation portion being disposed between the bias circuit portion and the microcontroller, pulse signals being passed or not passed between the first and second lines depending on whether the DC voltage across the differential line pair is above or below the breakdown voltage of the bias circuit diode being detectable by the microcontroller, and said low pass filter impeding said pulse signals from traveling out onto the differential line pair and said DC isolation portion impeding DC signals from interfering with the microcontroller and isolating the differential line pair from the microcontroller and other elements which are connectable thereto.

2. A system as set forth in claim 1, wherein said system is configured for monitoring a differential line pair of a POTS line.

3. A system as set forth in claim 2, wherein said system is configured to monitor at least one of an on hook and an off hook DC voltage state of said POTS line.

4. A system as set forth in claim 1, wherein the bias circuit portion comprises a plurality of Zener diodes and the system enables monitoring of the differential line pair without knowing its polarity.

5. A system as set forth in claim 3, wherein a breakdown voltage of a Zener diode of the bias circuit portion is selected as a threshold voltage such that voltages across the line pair in an on hook state are above the threshold voltage and voltages across the line pair in an off hook state are below the threshold voltage.

6. A system as set forth in claim 5, wherein the microcontroller is configured to detect a ring condition on the POTS line.

7. A system as set forth in claim 6, wherein said ring condition is detected by counting voltage swings across the threshold voltage over a selected time interval.

8. A system as set forth in claim 7, wherein the system is configured to detect a first ring and then signal an enablement of a read of caller ID information during a time interval between said first ring and a second ring.

9. A system as set forth in claim 8, wherein the system is configured to ignore caller ID signals at other times.

10. A telephone system monitoring system configured to detect at least one of on hook and off hook DC states of a differential POTS line pair, comprising:
a detection circuit configured to isolate the line pair from the rest of the detection circuit by means of capacitors in the line pair; said detection circuit further comprising means for sending pulse signals across the capacitors and means for returning or preventing return of the pulse signals depending upon whether the DC voltage differential across the line pair is above or below a selected threshold value;
means for indicating whether the voltage across the differential line pair is at least one of above or below the threshold value.

11. A system as set forth in claim 10, further comprising means for detecting a ring condition on the POTS line.

12. A system as set forth in claim 10, further comprising means for indicating initiation and termination of a call based on differentiating an on hook and an off hook DC voltage state corresponding to the DC voltage across the differential line pair being above or below the threshold voltage.

13. A system as set forth in claim 11, further comprising means for identifying a window for capturing caller ID information in a signal carried by the differential line pair.

14. A system as set forth in claim 10, wherein the means for sending pulse signals includes an appropriately programmed microcontroller.

15. A system as set forth in claim 10, wherein the detection circuit comprises means for minimizing the disruption of the DC voltage of the POTS differential line pair by the detection circuit.

16. A system as set forth in claim 15, wherein the means for minimizing disruption includes a low pass filter.

17. A system as set forth in claim 16, wherein the detection circuit further comprises a protection circuit portion configured to minimize effects of anomalous voltage and current conditions on the differential line pair on the microcontroller.

18. A system as set forth in claim 10, wherein the detector circuit is configured to function regardless of polarity of the differential line pair.

19. A system as set forth in claim 14, wherein the programmed microcontroller comprises means to minimize the effects of noise on the differential line pair on detection of the DC state of the differential line pair.

20. A system as set forth in claim 10, wherein the pulse signals are square wave pulse signals.

21. A system as set forth in claim 20, wherein the pulse signals are initiated at time intervals of less than 16 milliseconds.

22. A system as set forth in claim 21, wherein the pulse signals are less than 20 microseconds in length from positive edge to negative edge.

23. A system as set forth in claim 14, wherein the microcontroller includes a data link capability to communicate with another processor.

24. A system as set forth in claim 23, wherein the microcontroller capability is minimized and timing and logic functions are moved to said another processor.

25. A system as set forth in claim 23, wherein the microprocessor capability is maximized and the detection circuit is connected to a user interface.

26. A system as set forth in claim 23, wherein the detection circuit is implemented on a PC card.

27. A system as set forth in claim 23, wherein the detection circuit is implemented in a separately powerable unit data connectable to a computer.

28. A system configured for a detection of at least one of a ring condition and off hook condition on a differential line pair in a telephone network, comprising:
a low pass filter comprising a first and second resistor on a first line of a differential line pair and a third and fourth resistor on a second line of the differential line pair, wherein a first capacitor is electrically coupled to the first line and second line between the first and second resistor of the first line and the third and fourth resistor of the second line;
a bias circuit portion electrically coupled to an output of the low pass filter comprising a first Zener diode in series with and in opposite polarity from and a second Zener diode, each Zener diode having a break down voltage so that a change in voltage can be detected on either the first line and the second line of the differential line pair;
a DC isolation circuit portion electrically coupled to an output of the bias circuit comprising a second capacitor on the first line of the differential line pair and a third capacitor on the second line of the differential line pair;
a protection circuit portion connected to an output of the DC isolation circuit for protecting surges and spikes in a differential line; and
a microcontroller for detecting the state of the differential line pair having a digital output coupled to the second line for generating pulses and having an input electrically coupled to the first line of the differential line pair for detecting whether the pulses are present at a voltage level greater than a preset level.

29. A system configured for a detection of at least one of a ring condition and off hook condition on a differential line pair in a telephone network, comprising:
a low pass filter electrically coupled to a bias circuit;
the bias circuit wherein a first Zener diode is in series with and in opposite polarity from and a second Zener diode, each Zener diode having a break down voltage so that a change in voltage can be detected between on either a first line and a second line on a differential line pair;
a DC isolation circuit electrically coupled to the bias circuit and electrically coupled to a protection circuit for protecting surges and spikes in the differential line; and
a microcontroller having a digital output coupled to a line on the differential line pair for generating pulses and having an input electrically coupled to the other line of the differential line pair for detecting whether the pulses are present at a voltage level greater than a preset level.

30. A method for measuring a change in DC voltage on a differential line pair used in a telephone network connected to a microcontroller, comprising the steps of:
injecting a pulse signal from a microprocessor onto a first line of a differential line pair;
biasing the differential line pair with a bias circuit comprising a first Zener diode that is in series with and in opposite polarity to a second Zener diode, each Zener diode having a break down voltage so that a change in voltage can be detected on either the first line or a second line of the differential line pair;
isolating the microcontroller from a DC voltage on the differential line pair;
protecting the microcontroller from surges and spikes on the differential line pair;
detecting the microcontroller-generated pulse on the second line of the differential line pair with the microprocessor when the voltage difference between the first line of the differential line pair and the second line of the differential line pair is greater than a preset level.
